(19) United States
(12) Patent Application Publication
(10) Pub. No.: US 2020/0327887 A1
(43) Pub. Date: Oct. 15, 2020

(54) DNN BASED PROCESSOR FOR SPEECH RECOGNITION AND DETECTION

(71) Applicant: Apple Inc., Cupertino, CA (US)

(72) Inventors: Sarmad Aziz Malik, Cupertino, CA (US); Charles P. Clark, Mountain View, CA (US); Devang K. Naik, San Jose, CA (US); Srikanth Vishnubhotla, Santa Clara, CA (US)

(21) Appl. No.: 16/380,504

(22) Filed: Apr. 10, 2019

(51) Int. Cl. G10L 15/22; G10L 21/0232; G10L 15/16; H04R 1/40; H04R 3/00; G10L 15/30

(52) U.S. Cl. CPC G10L 15/22; G10L 21/0232; G10L 15/16; G10L 2021/02082; H04R 3/005; G10L 15/30; H04R 1/406

(57) ABSTRACT

Audio signals produced by microphones can be processed to remove echo and reverberation. The processed signals can be mapped to each other with adaptively estimated impulse responses. One or more of the processed signals, one or more of the mapped signals, and one or more of the impulse responses can be fed to an automatic speech recognizer (ASR) having a deep neural network (DNN), to train the DNN or recognize speech in the input audio signals. Other aspects are described and claimed.

### FIELD

One aspect of the disclosure relates to processing audio signals for speech recognition or detection.

### BACKGROUND

Automatic speech recognition (ASR) enables recognition and symbolization of spoken language by computers. ASR can recognize speech in sound. The recognized speech can be useful for various purposes, including transcribing, voice command processing, and more.

### SUMMARY

Devices can have a plurality of microphones (e.g. a microphone array) and reference audio channels. Reference audio channels can be used to drive a plurality of speakers. Output from speakers, e.g., a song, can drown out speech and make ASR more difficult, especially when loud. Training and deployment of deep neural networks (DNN) used in multi-channel ASR can improve successful recognition in harsh environments having noise, echo, reverberation, and multiple speakers. In some aspects, trigger phrases, spoken by a speaker and picked up by one or more of the microphones can be detected by the ASR.

Conventionally, beamformers can be used to reduce interfering noises during ASR. Beamforming, however, can add computational load on front-end processing (e.g., digital signal processing) of audio. Blind source separation and noise filtering (e.g., multi-channel Wiener filter) can also add computational load on front-end processing. Furthermore, DNNs can provide improved residual echo suppression over conventional front-end techniques.

In one aspect, processing audio for ASR can include: receiving a plurality of input audio signals from the plurality of microphones, the plurality of microphones capturing a sound field; processing the plurality of input audio signals to remove echo and reverberation, resulting in dereverberated signals; selecting, from the dereverberated signals, a reference dereverberated signal; mapping unselected dereverberated signals to the reference dereverberated signal with impulse responses that are adaptively estimated, resulting in adaptively and linearly mapped signals; and feeding, to an automatic speech recognizer having a DNN, the following: a) one or more of the dereverberated signals, b) one or more mapped signals, the mapped signals being based on the adaptively and linearly mapped signals, and c) one or more of the impulse responses, to train the DNN or recognize speech in the input audio signals.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 illustrates an audio processing system generating inputs for ASR, according to one aspect.

FIG. 2 illustrates an audio processing system generating inputs for ASR, according to one aspect.

FIG. 3 illustrates a process for processing audio, according to one aspect.

FIG. 4 illustrates an audio processing system, according to one aspect.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

Aspects of the disclosure can include a system, device, article of manufacture, or process. These aspects can include, for example, a smart speaker, smart headphones, a laptop computer, a desktop computer, a mobile phone, a smart phone, a tablet computer home, an audio system, any consumer electronics device with audio capability, and an audio system in a vehicle (e.g., an automobile infotainment system).

Audio Processing System with Mapping Based Spatial Cues for ASR

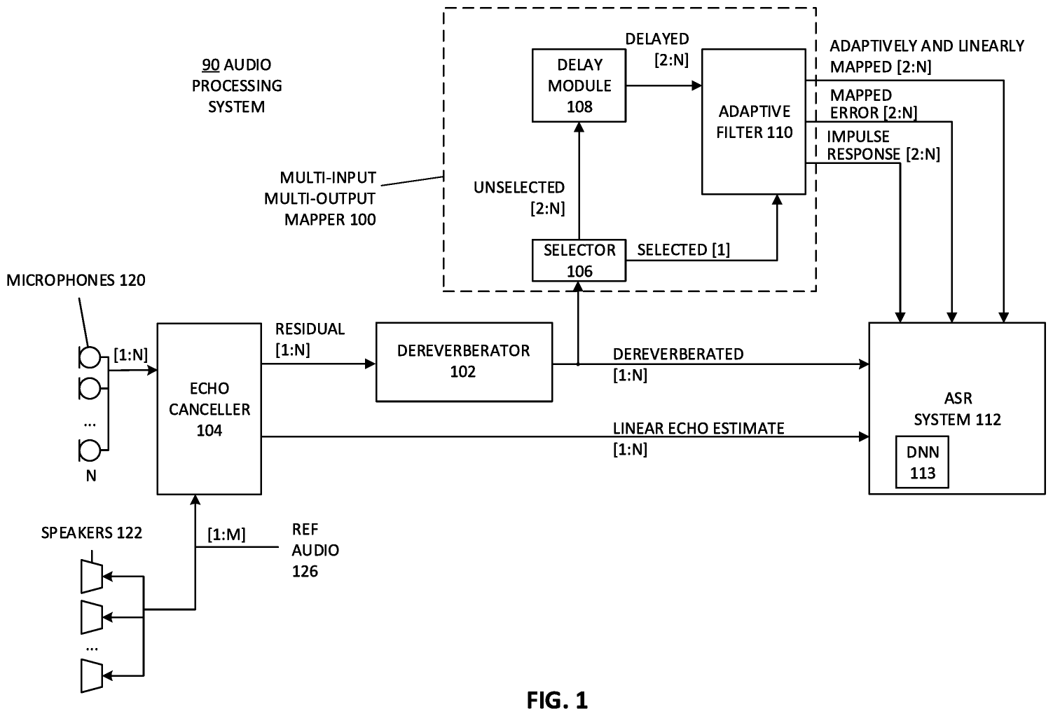

Referring now to FIG. 1, an audio processing system 90 is shown. The device or article of manufacture can include a plurality of microphones 120, and a processor configured to process the input audio signals. The plurality of input audio signals is processed to remove echo and reverberation, resulting in echo cancelled and dereverberated signals. A reference dereverberated signal is selected from the dereverberated signals and mapped to the unselected dereverberated signals with adaptively estimated impulse responses, resulting in adaptively and linearly mapped signals. An ASR 112 having a DNN 113 is fed the following inputs: a) one or more of the dereverberated signals, b) one or more mapped signals, the mapped signals being based on the adaptively and linearly mapped signals, and c) one or more of the impulse responses, to train the DNN or recognize speech (including one or more trigger phrases) in the input audio signals. This is described in detail below. It should be understood that, ‘dereverberated signals’ refers to echo cancelled and dereverberated signals. For brevity, however, those processed signals are referred to as dereverberated signals.

### Microphone Audio Input

A plurality of N microphones 120 can produce N input audio signals. In one aspect, the N microphones can have fixed locations on a device, forming a microphone array. The audio signals can be processed to remove echo and reverberation. In one aspect, speakers 122 are housed in the same device as microphones 120, e.g., in a smart phone, headphones, smart speaker, laptop, tablet computer, etc. The speakers can be driven by M reference audio channels 126.

### Echo Canceller

An echo canceller 104 can remove echo (e.g. linear echo) in each of the input audio signals. Echo can be caused by sound (e.g., songs, news programs, etc.) emitted from speakers 122. The echo canceller can adaptively (e.g. on a frame by frame basis in a time-varying manner) compute or estimate linear echo based on the reference audio channels and input audio signals. The linear echo estimates can be used to subtract or remove from the input audio, the estimated linear echo, thereby generating N residual audio signals with linear echo removed. In some cases, residual linear echo and nonlinear echo can still be present in the N residual audio signals.

Nonlinear echo can be caused by mechanical vibrations or magnetic properties of electronic components involved. For example, if the system is or contains a loudspeaker, driving the loudspeaker can cause mechanical vibrations that can generate nonlinear echo components. The linear echo estimates of each channel can be fed to the DNN for training and during runtime for recognition. The trained DNN can remove non-linear echo and residual linear echo present in the input audio signals (e.g., in the selected dereverberated signal and in the corresponding linearly mapped signals) based on the linear echo estimates and the other inputs. By offloading the residual echo suppression to the ASR, the system can reduce computational load on the front-end processing of the audio signals. Apart from reducing computational load, compared to a conventional front-end residual echo suppressor, a DNN/ASR system is able to better model underlying system nonlinearity in multi-dimensional hyperspace.

### Dereverberator

A dereverberator 102 can remove reverberation from the residual audio signal, resulting in N dereverberated signals. Dereverberation, if not performed carefully (e.g., too aggressively), can remove spatial cues captured in the differences between the audio signals. To preserve the differences between the audio signals, regularization can be performed on the signals. In one aspect, the dereverberator removes reverberation from the residual audio signal utilizing the principle of multi-channel linear prediction (MCLP). Other known dereverberation techniques can be used.

### Mapper

A multi-input multi-output (MIMO) mapper 100 can generate, from the processed audio signals (e.g., echo-cancelled and dereverberated), one or more adaptively and linearly mapped signals, one or more mapped error signals, and one or more impulse responses. In one aspect, selector 106 can select one of the processed audio signals (e.g. the echo canceled and dereverberated output of the dereverberator 102) to map the remaining (or unselected) processed signals to adaptively and linearly map the selected signal onto the unselected processed signals. In one aspect, based on knowledge of device (e.g. device geometry), and an arrangement of microphones, and/or detected objects (such as walls), a microphone and corresponding audio signal can be selected by the selector.

A delay module 108 can delay each of the unselected channels so that the features in the unselected channels can be compared to the features of the selected channel. This can prevent the case where one or more of the unselected channels arrive earlier in time than the selected channel (e.g., the sound arrived earlier at those unselected channels) and the features in those unselected channels cannot be compared to the selected channel, because such features have yet to appear in the selected channel. Thus, the delay ensures that the adaptive filter can first find features in the selected audio signal to map to the remaining channels. In one aspect, the delay is a maximum geometric delay, determined by a maximum time delay of sound arrival between the microphones. In one aspect, although not shown in the figure as such, the selected dereverberated signal can be delayed and mapped against each of the unselected dereverberated signals.

The adaptive filter 110 can map each of the unselected signals to the selected signal with adaptively estimated (e.g., time varying) impulse responses, resulting in adaptively and linearly mapped signals. Adaptively estimated impulse responses h(t) can be given by corresponding transfer functions H(S). The adaptive filter can include one or more linear filters specified by one or more transfer functions. Parameter variables of the transfer functions can be adjusted according to an optimization algorithm (e.g., to reduce or minimize a cost function based on the mapping error).

For example, a selected dereverberated signal ‘a’ can be mapped to an unselected dereverberated signal ‘b’ by convolving ‘a’ with an adaptively estimated impulse response h(t) to minimize an error. The error can be determined based on the difference between each of the mapped signals and the unselected signals. In one aspect, the error is a minimum mean square error (MMSE). In one aspect, the adaptive filter maps the selected signal onto each of the unselected signals to phase align the signals. Each of the error signals can indicate a difference between the linearly and adaptive mapped reference signal and the corresponding unselected signals.

### Inputs to the ASR

The time varying error signals, adaptively and linearly mapped signals, and adaptively estimated impulse responses can represent or indicate spatial cues of the sound captured by the microphones and, as such, can be used to train the DNN of the ASR 112. The spatial cues can help detect or recognize speech in the original audio signals amid noise, multiple speakers, and residual linear and non-linear noise. By training and processing such spatial cues, the DNN can perform frequency adjustments to aid in speech recognition that would otherwise be performed by front end processing such as beamforming and/or residual echo suppression.

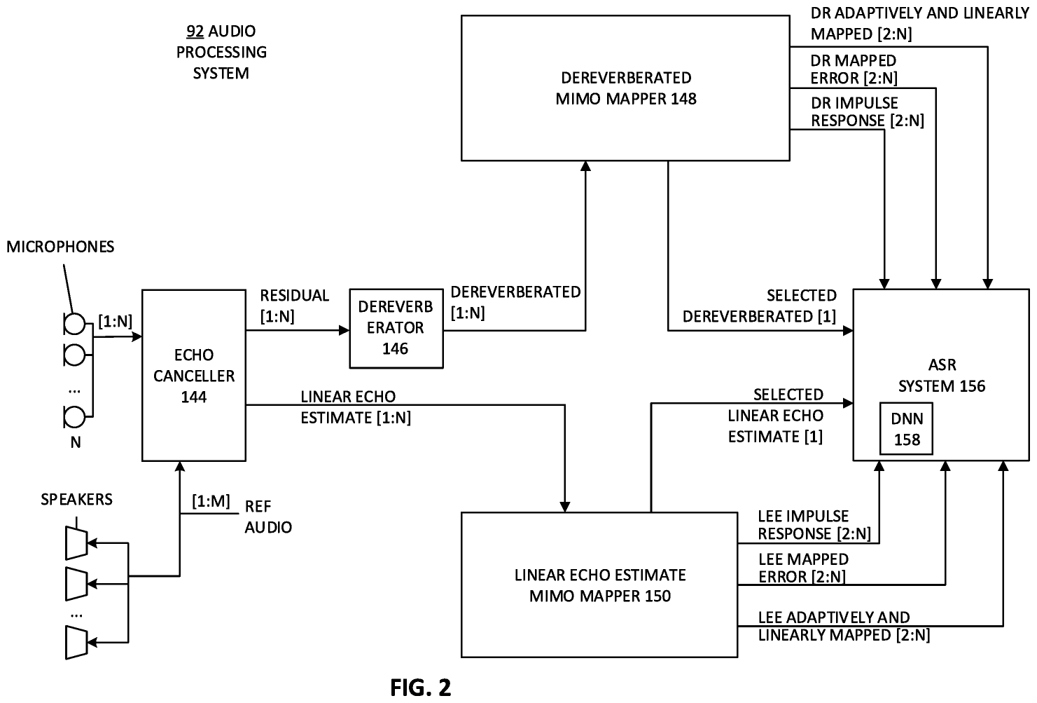

In one aspect, the following signals are fed to the ASR for training of the DNN or recognition of speech: a) one or more of the dereverberated signals, b) one or more mapped signals, the mapped signals being based on the adaptively and linearly mapped signals, c) one or more of the impulse responses, and e) one or more mapped error signals. In one aspect, all of the dereverberated signals are sent to the ASR as shown in FIG. 1. Alternatively, the selected dereverberated signal (e.g. selected by selector 106) can be sent to the ASR, as shown in FIG. 2.

The one or more mapped signals can be formed based on the adaptively and linearly mapped signals can be fed to the ASR to train the DNN or recognize speech in the input audio signals. In one aspect, each of the adaptively and linearly mapped signals can be used to train the ASR as shown in FIG. 1. In this case, the one or more mapped signals are the adaptively and linearly mapped signals.

Alternatively, a single mapped signal can be formed, for example, by summing, averaging, or selecting from the adaptively and linearly mapped signals. Similarly, rather than feed the ASR all of the impulse responses, one impulse response can be selected. In one embodiment, one or more compressed or reduced-dimensions versions of the impulse responses can be determined based on the impulse responses. Similarly, the one or more error signals can summed, averaged, or selected as input to the ASR, or all can be sent to the ASR. Reducing the inputs to the DNN can prevent unwanted expansion of the DNN (e.g., added neural network layers) which can reduce DNN complexity and minimize training duration and computation load during runtime.

In one aspect, the error signal(s) is not fed into the ASR/DNN. The error signals indicate differences between the mapped selected signal and unselected signals. The DNN can be trained to calculate this difference between the linearly mapped signal(s) and the dereverberated signal.

It should be understood that training of the ASR with the input signals as shown in FIG. 1 and FIG. 2 can include combinations and derivatives of the input signals, e.g., Mel-Frequency Cepstral Coefficients (MFCCs), filter-bank features, and more.

### Automatic Recognition System (ASR)

ASR 112 contains a DNN 113. The DNN can be implemented through various architectures including: recurrent neural network (RNN), convolutional deep neural network (CDNN), long short-term memory units (LSTMs), and more. The ASR can be configured to recognize speech based on the processed audio signal (having reverberation and linear echo removed) and spatial cues in the one or more input response, mapped error, and linearly mapped signals. The ASR can symbolize recognized speech, e.g., generate strings of characters that combine to form words in a language, based on the recognized speech. For example, based on recognized speech in the audio signals, the ASR can generate the string “Hello Sir. What is today's weather?”

In one aspect, the ASR can perform voice trigger detection, where the DNN is trained to recognize one or more phrases such as ‘Hello Miss’ or ‘Okay Mister’. In one aspect, the ASR is deployed on a networked device (e.g., a server). Alternatively or additionally, the ASR can be deployed on the capture device having the microphones. In one aspect no beamforming or residual echo suppression is performed on the front-end processing (e.g., outside of the ASR), because these tasks can be performed by the ASR and DNN, based on spatial cues in the inputs. The DNN can remove residual linear and non-linear echo and perform frequency adjustments (e.g., effectively amounting to null steering) to remove interference and noise. Front-end processing is reduced by the DNN and an improved speech recognition and detection can be realized.

Processing Linear Echo Estimate with Adaptive Filter

As was the case in FIG. 1, FIG. 2 also shows an echo canceller 144 and dereverberator 146 processing the input audio signals to remove linear echo and reverberation. Dereverberated mapper 148 maps the selected dereverberated signal to the unselected dereverberated signals, producing outputs (mapped signals, mapper error signals, and impulse responses) that can be fed to ASR 156. In one aspect, as shown in FIG. 2, the selected dereverberated signal is input to the ASR, rather than all the dereverberated signals, as is the case shown in FIG. 1.

Referring back to FIG. 2, time varying linear echo estimates produced by the echo canceller 144 can be processed with a multi-input multi-output mapper. The mapper 150 can select a linear echo estimate and map the selected linear echo estimate onto the unselected linear echo estimates with adaptively estimated impulse responses, resulting in adaptively and linearly mapped echo estimates. Mapped error signals can indicate a difference between the selected and unselected linear echo estimates when mapped. It should be understood that the impulse responses here will likely vary from those generated for by mapper 148 which are used to map the reference dereverberated signal to unselected dereverberated signals, thus, the impulse responses of the mapper 148 can be described as a first set of impulse responses and the impulse responses of the mapper 150 can be described as a second set of impulse responses, the impulse responses being adaptively generated.

The ASR can receive, as inputs: a) one or more of the linear echo estimates, b) one or more of the mapped echo estimates, e.g., the adaptively and linearly mapped echo estimates or a single mapped echo estimate signal formed from combining the adaptively and linearly mapped echo estimates, c) one or more of the impulse responses or compressed/dimension-reduced versions thereof, and/or e) the mapped error signals. The linear echo estimates, mapped error signals, and mapped echo estimates can be combined (e.g. averaged or summed) or selected for input to the ASR. Based on the inputs, the DNN can be trained and the ASR can suppress nonlinear echo and/or residual linear echo in the input signals.

### Process

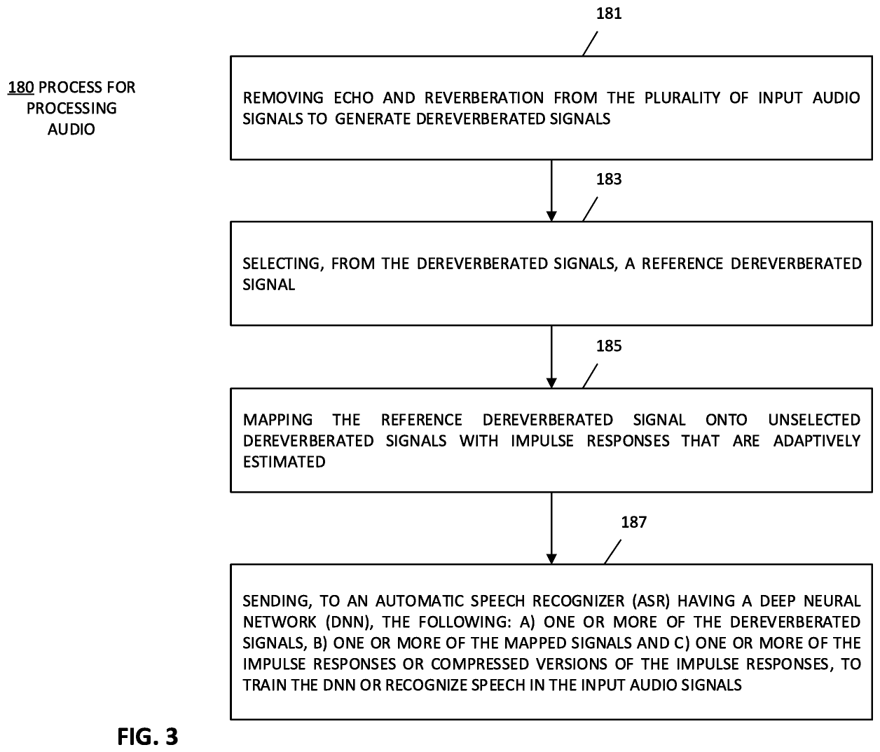

In one aspect, as shown in FIG. 3, a process 180 is described for processing audio signals produced by microphones. At block 181, the process includes processing the plurality of input audio signals to remove echo and reverberation, resulting in dereverberated signals. At block 183, the process includes selecting, from the dereverberated signals, a reference dereverberated signal. At block 185, the process includes mapping the reference dereverberated signal onto the unselected dereverberated signals with impulse responses that are adaptively estimated, resulting in adaptively and linearly mapped signals. At block 187, the process includes feeding, to an ASR having a DNN, the following: a) one or more of the dereverberated signals, b) one or more of the mapped signals, e.g., the adaptively and linearly mapped signals or a single mapped signal formed from combining the adaptively and linearly mapped signals, and c) one or more of the impulse responses, to train the DNN or recognize speech and/or a trigger phrase in the input audio signals.

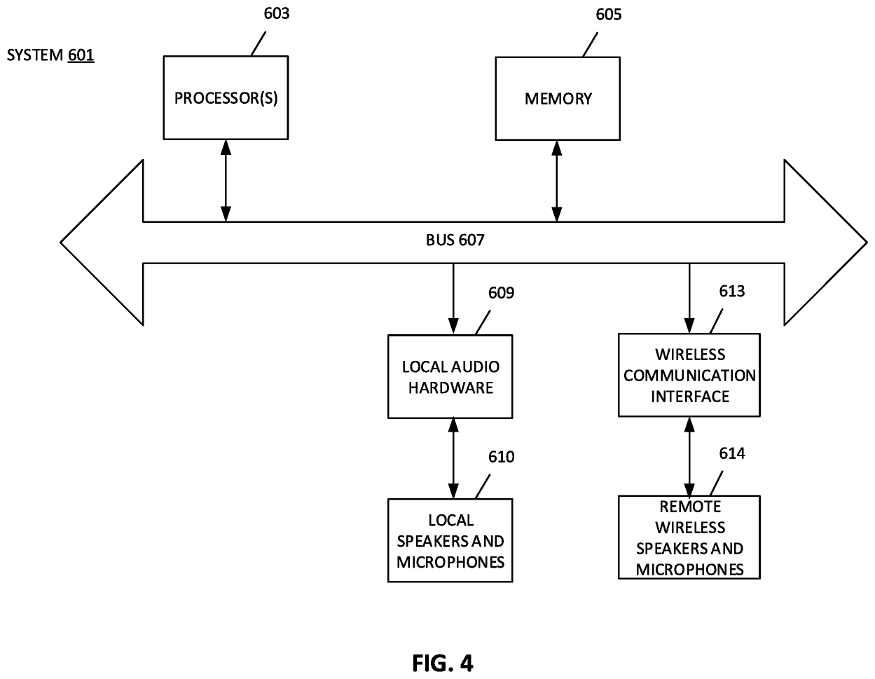

FIG. 4 shows a block diagram for explaining an example of an audio processing system hardware which may be used with any of the aspects described herein. This audio processing system can represent a general purpose computer system or a special purpose computer system. Note that while FIG. 4 illustrates the various components of an audio processing system that may be incorporated into headphones, speaker systems, microphone arrays and entertainment systems, it is merely one example of a particular implementation and is merely to illustrate the types of components that may be present in the audio processing system. FIG. 4 is not intended to represent any particular architecture or manner of interconnecting the components as such details are not germane to the aspects herein. It will also be appreciated that other types of audio processing systems that have fewer components than shown or more components than shown in FIG. 4 can also be used. Accordingly, the processes described herein are not limited to use with the hardware and software of FIG. 4.

As shown in FIG. 4, the audio processing system 601 (for example, a laptop computer, a desktop computer, a mobile phone, a smart phone, a tablet computer, a smart speaker, or an infotainment system for an automobile or other vehicle) includes one or more buses 607 that serve to interconnect the various components of the system. One or more processors 603 are coupled to bus 607 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 605 can include Read Only Memory (ROM), volatile memory, and non-volatile memory, or combinations thereof, coupled to the bus 607 using techniques known in the art.

Memory can include DRAM, a hard disk drive or a flash memory or a magnetic optical drive or magnetic memory or an optical drive or other types of memory systems that maintain data even after power is removed from the system. In one aspect, the processor 603 retrieves computer program instructions stored in a machine readable storage medium (memory) and executes those instructions to perform operations described herein.

Local audio hardware 609 is coupled to the one or more buses 607 in order to receive audio signals to be processed and output by local speakers 610. Local audio hardware 609 can comprise digital to analog and/or analog to digital converters. Local hardware 609 can also include audio amplifiers and filters. The Local audio hardware can also interface with local microphones (e.g., microphone arrays) to receive audio signals (whether analog or digital), digitize them if necessary, and communicate the signals to the bus 607. Local microphones and local speakers can be located in the same housing as the system 601, for example, they can be speakers in a mobile phone, tablet, smart speaker, or other forms that system 601 can take.

Wireless communication interface 613 can communicate with remote devices and networks. For example, wireless communication interface 613 can communicate over known technologies such as Wi-Fi, 3G, 4G, 5G, Bluetooth, ZigBee, or other equivalent technologies. Wireless communication interface 613 can communicate (e.g., receive and transmit data) with networked devices such as servers (e.g., the cloud) and/or other devices such as remote wireless speakers and microphones 614. Remote speakers and microphones can also be connected be integrated into system 601 through wired connections, as known in the art.

It will be appreciated that the aspects disclosed herein can utilize memory that is remote from the system, such as a network storage device which is coupled to the audio processing system through a network interface such as a modem or Ethernet interface. The buses 607 can be connected to each other through various bridges, controllers and/or adapters as is well known in the art. In one aspect, one or more network device(s) can be coupled to the bus 607. The network device(s) can be wired network devices (e.g., Ethernet) or wireless network devices (e.g., WI-FI, Bluetooth).

Various aspects descried herein may be embodied, at least in part, in software. That is, the techniques may be carried out in an audio processing system in response to its processor executing a sequence of instructions contained in a storage medium, such as a non-transitory machine-readable storage medium (e.g. DRAM or flash memory). In various aspects, hardwired circuitry may be used in combination with software instructions to implement the techniques described herein. Thus the techniques are not limited to any specific combination of hardware circuitry and software, or to any particular source for the instructions executed by the audio processing system.

In the description, certain terminology is used to describe features of various aspects. For example, in certain situations, the terms “analyzer”, “extractor”, “renderer”, “estimator”, “combiner”, “processor”, “synthesizer”, “component,” “unit,” “module,” “mapper”, “canceller”, “selector”, “filter”, “system” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

Some portions of the preceding detailed descriptions have been presented in terms of algorithms and symbolic representations of operations on data bits within a computer memory. These algorithmic descriptions and representations are the ways used by those skilled in the audio processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined or removed, performed in parallel or in serial, as necessary, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as, special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination hardware devices and software components.

While certain aspects have been described and shown in the accompanying drawings, it is to be understood that such aspects are merely illustrative of and not restrictive on the broad invention, and the invention is not limited to the specific constructions and arrangements shown and described, since various other modifications may occur to those of ordinary skill in the art. The description is thus to be regarded as illustrative instead of limiting.

For example, FIG. 1 depicts a system that selects a dereverberated signal to map onto unselected dereverberated signals. All dereverberated signals are sent to the ASR. FIG. 2, however, shows that the selected dereverberated signal can be used as input to the ASR. Other aspects are described herein where inputs to the ASR are combined (e.g., averaged or summed) or selected to minimize input to the ASR for prevent negative impacts such as unwanted expansion of DNN.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A method performed by a processor of a device having a plurality of microphones, comprising:
receiving a plurality of input audio signals from the plurality of microphones, the plurality of microphones capturing a sound field;
removing echo and reverberation from the plurality of input audio signals to generate dereverberated signals;
selecting, from the dereverberated signals, a reference dereverberated signal;
mapping the reference dereverberated signal onto unselected dereverberated signals with impulse responses that are adaptively estimated; and
sending, to an automatic speech recognizer (ASR) having a deep neural network (DNN), the following: a) one or more of the dereverberated signals, b) one or more of the mapped signals and c) one or more of the impulse responses or compressed versions of the impulse responses, to train the DNN or recognize speech in the input audio signals.

2. The method according to claim 1, further comprising
sending, to the ASR, one or more error signals, each error signal indicating a difference between the reference dereverberated signal and one of the unselected dereverberated signals when mapped.

3. The method according to claim 1, wherein the one or more mapped signals is a single mapped signal formed from combining the mapped signals.

4. The method according to claim 1, wherein the mapped signals sent to the ASR include all mappings of the reference dereverberated signal mapped onto the unselected dereverberated signals.

5. The method according to claim 1, wherein the unselected dereverberated signals are delayed by a maximum geometric time delay, prior to mapping.

6. The method according to claim 1, wherein
removal of the echo includes a) determining linear echo estimates based on the input audio signals and audio reference channels, and b) removing the echo from the input audio signals based on the linear echo estimates; and
the linear echo estimates are sent to the DNN of the ASR to suppress echo in the input audio signals or to train the DNN.

7. The method, according to claim 1, wherein the ASR is deployed on the device.

8. The method, according to claim 1, wherein the ASR is deployed on a networked device in communication with the device.

9. The method according to claim 1, wherein no beamforming or non-linear echo suppression is performed outside of the ASR.

10. The method according to claim 1, wherein
removal of the echo includes a) determining linear echo estimates based on the input audio signals and audio reference channels, and b) removing the echo from the input audio signals based on the linear echo estimates; and
the method further comprises:
selecting, from the linear echo estimates, a reference linear echo estimate;
mapping the reference linear echo estimate onto unselected linear echo estimates with a second set of impulse responses that are adaptively estimated; and
sending, to the ASR, the following: a) one or more of the linear echo estimates, b) one or more of the mapped echo estimates, and c) one or more of the second set of impulse responses or compressed versions of the second set of impulse responses, to suppress echo in the input audio signals or to train the DNN.

11. The method according to claim 10, wherein
the one or more of the linear echo estimates fed to the ASR is the reference linear echo estimate, and
the one or more of the mapped echo estimates is a single mapped echo estimate signal, formed from combining the mapped estimates.

12. The method according to claim 10, further comprising
feeding, to the ASR, one or more linear echo error signals, each linear echo error signal indicating a difference between the reference linear echo estimate and one or more of the unselected linear echo estimates when mapped.

13. An article of manufacture comprising:
a plurality of microphones; and
a machine readable medium having stored therein instructions that, when executed by a processor of the article of manufacture, cause the article of manufacture to perform the following:
receiving a plurality of input audio signals from the plurality of microphones, the plurality of microphones capturing a sound field;
removing echo and reverberation from the plurality of input audio signals to generate dereverberated signals;
selecting, from the dereverberated signals, a reference dereverberated signal;
mapping the reference dereverberated signal onto unselected dereverberated signals with impulse responses that are adaptively estimated; and
sending, to an automatic speech recognizer (ASR) having a deep neural network (DNN), the following: a) one or more of the dereverberated signals, b) one or more of the mapped signals and c) one or more of the impulse responses or compressed versions of the impulse responses, to train the DNN or recognize speech in the input audio signals.

14. The article of manufacture according to claim 13, wherein the instructions further cause the article of manufacture to perform the following
sending, to the ASR, one or more error signals, each error signal indicating a difference between the reference dereverberated signal and one or more of the unselected dereverberated signals when mapped.

15. The article of manufacture according to claim 13, wherein the one or more mapped signals is a single mapped signal formed from combining the mapped signals.

16. The article of manufacture according to claim 13, wherein the mapped signals sent to the ASR includes all mappings of the reference dereverberated signal onto the unselected dereverberated signals.

17. The article of manufacture according to claim 13, wherein the unselected dereverberated signals are delayed by a maximum geometric time delay, prior to mapping.

18. The article of manufacture according to claim 13, wherein
removal of the echo includes a) determining linear echo estimates based on the input audio signals and audio reference channels, and b) removing the echo from the input audio signals based on the linear echo estimates; and
the linear echo estimates are sent to the DNN of the ASR to suppress echo in the input audio signals or to train the DNN.

19. The article of manufacture according to claim 13, wherein the ASR is deployed locally, on the article of manufacture.

20. The article of manufacture according to claim 13, wherein the ASR is deployed remotely on a networked device in communication with the article of manufacture.
